(19) United States
(12) Patent Application Publication
(10) Pub. No.: US 2023/0401886 A1
(43) Pub. Date: Dec. 14, 2023

(54) TOUCH SENSING IN NON-CAPACITIVE TOUCH MODES

(71) Applicant: QUALCOMM Incorporated, San Diego, CA (US)

(72) Inventors: Kritpal Singh DHINDHSA, Hyderabad (IN); Rakesh PALLERLA, Hyderabad (IN); Raj KUMAR, San Diego, CA (US)

(21) Appl. No.: 17/806,233

(22) Filed: Jun. 9, 2022

(51) Int. Cl. G06V 40/13; G06F 3/044; G06F 3/041; G06F 3/04886

(52) U.S. Cl. CPC G06V 40/1306; G06F 3/044; G06F 3/0414; G06F 3/04886

(57) ABSTRACT

In some implementations, a method may involve detecting that touch sensing using a capacitive touch sensor system is inoperable in a given user context. Touch sensing using the capacitive touch sensor is disabled and touch sensing using an alternative sensor system is enabled. The alternative sensor system may include a fingerprint sensor system, an optical sensor system, and a force sensor system. Touch sensing using the alternative sensor system may be limited to a designated portion in a graphical user interface for improved user experience. In some implementations, the designated portion may be coextensive with an active area of the fingerprint sensor system and user interface controls may be arranged into an array of tiles.

### TECHNICAL FIELD

This disclosure relates generally to touch screen devices and related methods, including but not limited to touch screen devices and methods that operate in modes using fingerprint sensor systems, optical sensor systems, force sensor systems, and other sensor systems for detecting touch.

### DESCRIPTION OF THE RELATED TECHNOLOGY

Touch screen devices are commonly featured in a variety of devices. Many touch screen devices including smartphones use capacitive touch screen technology to register user inputs on the touch screen device. Capacitive touch screen technology is largely displacing resistive touch screens due to industrial design, durability, and performance considerations. Generally, capacitive touch screens require “bare-handed” contact to sense a touch because a change in capacitance on the touch screen is induced by a small electrical charge drawn to a fingertip at a point of contact. This gives rise to a problem when a user is operating the touch screen device underwater or when the user is wearing protective gloves.

### SUMMARY

The systems, methods and devices of the disclosure each have several innovative aspects, no single one of which is solely responsible for the desirable attributes disclosed herein.

One innovative aspect of the subject matter described in this disclosure may be implemented in an apparatus. The apparatus may include a display, a capacitive touch sensor system, and one or more of the following: a fingerprint sensor system, an optical sensor system, or a force sensor system. The apparatus may further include a control system configured for communication with the capacitive touch sensor system, the fingerprint sensor system, and the display, where the control system is further configured for: determine that a user context of the apparatus is incompatible with touch sensing for the capacitive touch sensor system, and present a graphical user interface on the display of the apparatus, where the graphical user interface comprises a first portion configured for sensing touch using one or more of the following: the fingerprint sensor system, the optical sensor system, or the force sensor system.

According to some implementations, the first portion comprises a region of the display coextensive with an active area of the fingerprint sensor system. In some implementations, the graphical user interface further comprises a second portion, where the second portion of the graphical user interface is configured to display a video or image. In some implementations, the control system configured to determine that the user context is incompatible with touch sensing for the capacitive touch sensor system is configured to determine that the user context comprises one or more of the following: (i) the display of the apparatus is covered or submerged in water, (ii) a user wearing gloves, or (iii) a user utilizing a prosthetic or robotic hand.

According to some implementations, the control system is further configured to: obtain a location of a touch input on the graphical user interface using the fingerprint sensor system. In some implementations, the control system configured to obtain the location of the touch input on the graphical user interface using the fingerprint sensor system is configured to: divide the first portion of the graphical user interface into an array of tiles corresponding to active areas of the fingerprint sensor system, perform a scan of one or more tiles of the array of tiles using the fingerprint sensor system to identify a user's finger, and correlate the user's finger with one of the tiles in the first portion of the graphical user interface to obtain the location of the touch input. In some implementations, the control system configured to obtain the location of the touch input on the graphical user interface using the fingerprint sensor system is configured to: detect an applied force on the display using one or more pressure or force sensors associated with the force sensor system or fingerprint sensor system, perform a scan using the fingerprint sensor system to identify a user's finger, and correlate the user's finger with at least one tile in an array of tiles in the first portion of the graphical user interface to obtain the location of the touch input, where the array of tiles divides the first portion into a grid.

According to some implementations, the fingerprint sensor system comprises an ultrasonic fingerprint sensor system. The control system configured to obtain the location of the touch input on the graphical user interface using the fingerprint sensor system may be configured to: cause an ultrasonic transmitter or transceiver in the ultrasonic fingerprint sensor system to generate ultrasonic waves, receive reflections of the ultrasonic waves at a piezoelectric receiver array to acquire image data that identifies a stylus or pen in contact with a surface of the apparatus, and correlate the stylus or pen to a position in the first portion of the graphical user interface to obtain the location of the touch input using the image data. In some implementations, the control system configured to obtain the location of the touch input on the graphical user interface using the fingerprint sensor system may be configured to: receive an indication of mechanical deformation at a piezoelectric receiver array of the ultrasonic fingerprint sensor system to acquire image data that identifies a stylus or pen in contact with a surface of the apparatus, and correlate the stylus or pen to a position in the first portion of the graphical user interface to obtain the location of the touch input using the image data.

According to some implementations, the control system is further configured to: obtain a location of a touch input on the graphical user interface using the force sensor system, where the control system configured to obtain the location of the touch input using the force sensor system is configured to: detect an applied force from an object on the display, obtain a plurality of force measurements from a plurality of force sensors associated with the force sensor system, each of the plurality of force sensors positioned at different locations of the apparatus, and estimate a position of the object in the first portion of the graphical user interface based on the plurality of force measurements to obtain a location of the touch input.

Other innovative aspects of the subject matter described in this disclosure may be implemented in a method. The method may include determining, using a control system, that a user context of a touch screen device is incompatible with touch sensing for a capacitive touch sensor system of the touch screen device, and presenting, using the control system, a graphical user interface on a display of the touch screen device, where the graphical user interface comprises a first portion configured for sensing touch using one or more of the following: a fingerprint sensor system, an optical sensor system, or a force sensor system of the touch screen device.

According to some implementations, the first portion of the graphical user interface comprises a region of the display coextensive with an active area of the fingerprint sensor system. In some implementations, the graphical user interface further comprises a second portion, where the second portion of the graphical user interface is configured to display a video or image. In some implementations, the user context that is incompatible with touch sensing for the capacitive touch sensor system comprises one or more of the following: (i) the display of the touch screen device is covered or submerged in water, (ii) a user wearing gloves, or (iii) a user utilizing a prosthetic or robotic hand.

According to some implementations, the method further includes obtaining, using the control system, a location of a touch input on the graphical user interface using the fingerprint sensor system. In some implementations, obtaining the location of the touch input on the graphical user interface using the fingerprint sensor system comprises: dividing the first portion of the graphical user interface into an array of tiles corresponding to active areas of the fingerprint sensor system, performing a scan of one or more tiles of the array of tiles using the fingerprint sensor system to identify a user's finger, and correlating the user's finger with one of the tiles in the first portion of the graphical user interface to obtain the location of the touch input. In some implementations, obtaining the location of the touch input on the graphical user interface using the fingerprint sensor system comprises: detecting an applied force on the display using one or more pressure or force sensors associated with the force sensor system or fingerprint sensor system, performing a scan using the fingerprint sensor system to identify a user's finger, and correlating the user's finger with at least one tile in an array of tiles in the first portion of the graphical user interface to obtain the location of the touch input, where the array of tiles divides the first portion into a grid.

According to some implementations, the fingerprint sensor system comprises an ultrasonic fingerprint sensor system. In some implementations, obtaining the location of the touch input on the graphical user interface using the fingerprint sensor system comprises: causing an ultrasonic transmitter or transceiver in the ultrasonic fingerprint sensor system to generate ultrasonic waves, receiving reflections of the ultrasonic waves at a piezoelectric receiver array to acquire image data that identifies a stylus or pen in contact with a surface of the touch screen device, and correlating the stylus or pen to a position in the first portion of the graphical user interface to obtain the location of the touch input using the image data. In some implementations, obtaining the location of the touch input on the graphical user interface using the fingerprint sensor system comprises: receiving an indication of mechanical deformation at a piezoelectric receiver array of the ultrasonic fingerprint sensor system to acquire image data that identifies a stylus or pen in contact with a surface of the touch screen device, and correlating the stylus or pen to a position in the first portion of the graphical user interface to obtain the location of the touch input using the image data.

According to some implementations, the method further includes obtaining a location of a touch input on the graphical user interface using the optical sensor system.

According to some implementations, obtaining a location of a touch input on the graphical user interface using the force sensor system. Obtaining the location of the touch input using the force sensor system may comprise: detecting an applied force from an object on the display, obtaining a plurality of force measurements from a plurality of force sensors associated with the force sensor system, each of the plurality of force sensors positioned at different locations of the touch screen device, and estimating a position of the object in the first portion of the graphical user interface based on the plurality of force measurements to obtain a location of the touch input.

Some or all of the operations, functions and/or methods described herein may be performed by one or more devices according to instructions (e.g., software) stored on one or more non-transitory media. Such non-transitory media may include memory devices such as those described herein, including but not limited to random access memory (RAM) devices, read-only memory (ROM) devices, etc. Accordingly, some innovative aspects of the subject matter described in this disclosure can be implemented in one or more non-transitory media having software stored thereon.

For example, the software may include instructions for controlling one or more devices to perform a method. In some implementations, the method may involve determining that a user context of a touch screen device is incompatible with touch sensing for a capacitive touch sensor system of the touch screen device, and presenting a graphical user interface on a display of the touch screen device, where the graphical user interface comprises a first portion configured for sensing touch using one or more of the following: a fingerprint sensor system, an optical sensor system, or a force sensor system of the touch screen device.

According to some implementations, the user context that is incompatible with touch sensing for the capacitive touch sensor system comprises one or more of the following: (i) the display of the touch screen device is covered or submerged in water, (ii) a user wearing gloves, or (iii) a user utilizing a prosthetic or robotic hand.

In some implementations, the method may further involve obtaining a location of a touch input on the graphical user interface using the fingerprint sensor system. In some implementations, the method may further involve obtaining a location of a touch input on the graphical user interface using the force sensor system.

### BRIEF DESCRIPTION OF THE DRAWINGS

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale. Like reference numbers and designations in the various drawings indicate like elements.

FIG. 1 is a block diagram that shows example components of an apparatus according to some disclosed implementations.

FIG. 2 shows a flow diagram that provides examples of operations for detecting a user context for operating in a non-capacitive touch mode according to some disclosed implementations.

FIG. 3 shows a flow diagram that provides examples of operations for operating in a non-capacitive touch mode according to some disclosed implementations.

FIG. 4A shows an example ultrasonic image of a touch screen device submerged in water according to some implementations.

FIG. 4B shows an example ultrasonic image with water droplets on a surface of a touch screen device according to some implementations.

FIG. 5A shows an example of an apparatus with a graphical user interface (GUI) in a configuration that limits a touch-sensitive area of an application to a portion of the GUI according to some implementations.

FIG. 5B shows an example of an apparatus with a GUI in a configuration that limits a touch-sensitive area of a music player application to a portion of the GUI according to some implementations.

FIG. 6A shows an example of an apparatus with a GUI in a configuration that enables touch sensing in a capacitive touch sensing mode.

FIG. 6B shows an example of an apparatus with a GUI in a configuration that enables touch sensing in a non-capacitive touch sensing mode according to some implementations.

FIG. 6C shows an example of an apparatus with a GUI in a configuration that enables touch sensing in a non-capacitive touch sensing mode for an application according to some implementations.

FIG. 6D shows an example of an apparatus with a GUI in a configuration that enables touch sensing in a non-capacitive touch sensing mode for a camera application according to some implementations.

FIG. 6E shows an example of an apparatus with a GUI in a configuration that enables touch sensing in a non-capacitive touch sensing mode for a music player application according to some implementations.

FIG. 7A shows a cross-sectional schematic view of an example fingerprint sensor system configured for touch detection using mechanical deformation according to some implementations.

FIG. 7B shows a cross-sectional schematic view of an example fingerprint sensor system configured for touch detection using ultrasonic reflection according to some implementations.

FIG. 8 shows a schematic block diagram of an example force sensor system configured for touch detection using a plurality of force sensors according to some implementations.

### DETAILED DESCRIPTION

The following description is directed to certain implementations for the purposes of describing the innovative aspects of this disclosure. However, a person having ordinary skill in the art will readily recognize that the teachings herein may be applied in a multitude of different ways. The described implementations may be implemented in any device, apparatus, or system that includes a touch sensing system as disclosed herein. In addition, it is contemplated that the described implementations may be included in or associated with a variety of electronic devices such as, but not limited to: mobile devices, multimedia Internet enabled cellular telephones, mobile television receivers, wireless devices, smartphones, smart cards, wearable devices such as bracelets, armbands, wristbands, rings, headbands, patches, etc., Bluetooth® devices, personal data assistants (PDAs), wireless electronic mail receivers, hand-held or portable computers, netbooks, notebooks, smartbooks, tablets, printers, copiers, scanners, facsimile devices, global positioning system (GPS) receivers/navigators, cameras, digital media players (such as MP3 players), camcorders, game consoles, wrist watches, clocks, calculators, television monitors, flat panel displays, electronic reading devices (e.g., e-readers), mobile health devices, computer monitors, auto displays (including odometer and speedometer displays, etc.), cockpit controls and/or displays, camera view displays (such as the display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (such as in electromechanical systems (EMS) applications including microelectromechanical systems (MEMS) applications, as well as non-EMS applications), aesthetic structures (such as display of images on a piece of jewelry or clothing) and a variety of EMS devices. The teachings herein also may be used in applications such as, but not limited to, electronic switching devices, radio frequency filters, sensors, accelerometers, gyroscopes, motion-sensing devices, magnetometers, inertial components for consumer electronics, parts of consumer electronics products, steering wheels or other automobile parts, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

An increasing number of devices incorporate a touch screen that enable a user to interact with a graphical user interface via touch as an input. A user may rely on touch screen inputs as an alternative to physical buttons, keyboards, and other input devices. Many touch screen devices operate using capacitive touch screen technology. Typically, a capacitive touch screen device comprises an insulator (e.g., glass) coated with a transparent conductor (e.g., indium tin oxide). Since the human body can act as an electrical conductor, touching a touch screen results in a distortion of the touch screen's electrostatic field. The distortion is measurable as a change in capacitance, which, in turn, can be used to determine the location of contact on the touch screen.

There are various user contexts that may render a capacitive touch screen device inoperable. One situation occurs when the touch screen device is submerged under water. In such instances, the touch screen device is overwhelmed by the change in capacitance and essentially functions as if a huge finger is covering the touch screen uniformly, thereby hindering touch detection. Even for devices that claim to be water-resistant or water-proof, touch detection becomes poor or non-functional for such devices covered in water. Another situation occurs when a user is operating the touch screen device with gloves. Often, the material of a glove is an electrical insulator that insulates the user's fingers. This prevents a capacitive touch screen from detecting the conductivity of a fingertip through the glove. Thus, the capacitive touch screen may be inoperable while the user is wearing gloves. This presents a problem for users that wear gloves in cold weather conditions and for users that wear gloves in certain occupations or recreational activities to protect their hands. Similarly, another situation occurs when the user is operating the touch screen device with a prosthetic. Many prosthetic hands are made of a material that is electrically nonconductive so that the prosthetic hands are incapable of interacting with capacitive touch screen technologies.

Some of the disclosed methods, devices, and apparatuses involve operation of a touch screen device in a non-capacitive touch mode using alternative sensor systems such as a fingerprint sensor system, optical sensor system, or force sensor system. The touch screen device may detect a user context that is incompatible with touch sensing for a touch sensor system (e.g., capacitive touch sensor system) of the device. Upon detection of such a user context, the touch screen device may enter a non-capacitive touch mode where a designated portion of a graphical user interface is configured for sensing touch using alternative sensor systems to a capacitive touch sensor system. In some implementations, the designated portion may enable touch sensing using a fingerprint sensor system such as an ultrasonic fingerprint sensor system. In some examples, the fingerprint sensor system may perform a scan that identifies a user's finger on an active tile and then correlates the active tile to a location on the graphical user interface. In some examples, the fingerprint sensor system receives reflections of the ultrasonic waves to identify an object (e.g., stylus) to locate a position of the object, or the fingerprint sensor system may receive an indication of mechanical deformation caused by an object (e.g., stylus) to locate a position of the object. In some implementations, the designated portion may enable touch sensing using an optical sensor system to generate images to determine a location of user input. In some implementations, the designated portion may enable touch sensing using a force sensor system employing a plurality of force sensors to determine a location of a user input.

Particular implementations of the subject matter described in this disclosure may be implemented to realize one or more of the following potential advantages. User experience is enhanced by enabling touch sensing and recognition in an underwater environment, environments (e.g., cold weather) where the user is wearing gloves, situations where the user has prosthetic hands or robotic hands, or other environments that may ordinarily render touch sensing inoperable. This allows users to continue to operate their smartphones or other devices while swimming, while participating in water activities, while wearing gloves, while using prosthetic or robotic hands, etc. Functionality is improved by designating portions of a graphical user interface for touch sensing that correspond to active areas of alternative sensor systems. Less power is wasted by disabling a capacitive touch sensor system and enabling touch operation only in designated portions that correspond to active areas of alternative sensor systems. When using a fingerprint sensor system for touch sensing, power may be saved by reducing usage of the fingerprint sensor transmitter during scanning and reducing usage of fingerprint image processing. Touch recognition is also improved by dividing the designated portion of the graphical user interface into an array of tiles to assist in correlating user input with a location of the user input.

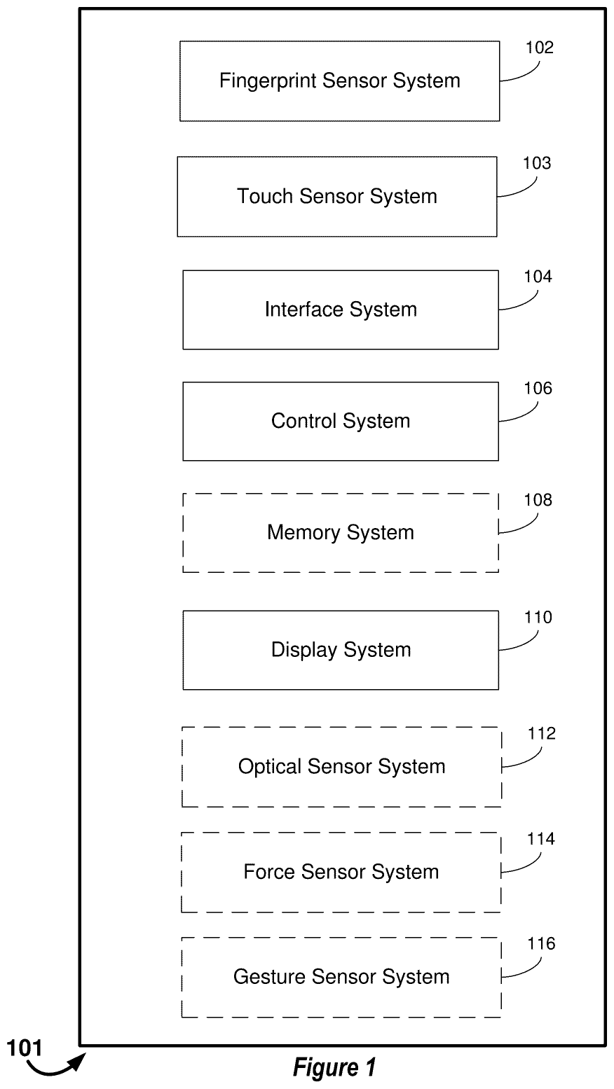

FIG. 1 is a block diagram that shows example components of an apparatus according to some disclosed implementations. In this example, the apparatus 101 includes a fingerprint sensor system 102, a touch sensor system 103, an interface system 104, a control system 106 and a display system 110. Some implementations may include a memory system 108, an optical sensor system 112, a force sensor system 114, and/or a gesture sensor system 116.

According to some examples, the fingerprint sensor system 102 may be, or may include, an ultrasonic fingerprint sensor. Alternatively, or additionally, in some implementations the fingerprint sensor system 102 may be, or may include, another type of fingerprint sensor, such as an optical fingerprint sensor, a photoacoustic fingerprint sensor, etc. In some examples, an ultrasonic version of the fingerprint sensor system 102 may include an ultrasonic receiver and a separate ultrasonic transmitter. In some such examples, the ultrasonic transmitter may include an ultrasonic plane-wave generator. However, various examples of ultrasonic fingerprint sensors are disclosed herein, some of which may include a separate ultrasonic transmitter and some of which may not. For example, in some implementations, the fingerprint sensor system 102 may include a piezoelectric receiver layer, such as a layer of polyvinylidene fluoride PVDF polymer or a layer of polyvinylidene fluoride-trifluoroethylene (PVDF-TrFE) copolymer. In some implementations, a separate piezoelectric layer may serve as the ultrasonic transmitter. In some implementations, a single piezoelectric layer may serve as both a transmitter and a receiver. The fingerprint sensor system 102 may, in some examples, include an array of ultrasonic transducer elements, such as an array of piezoelectric micromachined ultrasonic transducers (PMUTs), an array of capacitive micromachined ultrasonic transducers (CMUTs), etc. In some such examples, PMUT elements in a single-layer array of PMUTs or CMUT elements in a single-layer array of CMUTs may be used as ultrasonic transmitters as well as ultrasonic receivers.

Data received from the fingerprint sensor system 102 may sometimes be referred to herein as “fingerprint sensor data,” “fingerprint image data,” etc., although the data will generally be received from the fingerprint sensor system in the form of electrical signals. Accordingly, without additional processing such image data would not necessarily be perceivable by a human being as an image.

The touch sensor system 103 may be, or may include, a capacitive touch sensor system such as a surface capacitive touch sensor system or a projected capacitive touch sensor system. The touch sensor system 103 may be, or may include, other types of touch sensor systems such as a resistive touch sensor system, a surface acoustic wave touch sensor system, an infrared touch sensor system, or other suitable type of touch sensor system. Some of aforementioned touch sensor systems may be rendered inoperable for touch recognition depending on a user context (e.g., underwater). In some implementations, an area of the touch sensor system 103 may extend over most or all of a display portion of the display system 110.

In some examples, the interface system 104 may include a wireless interface system. In some implementations, the interface system 104 may include a user interface system, one or more network interfaces, one or more interfaces between the control system 106 and the fingerprint sensor system 102, one or more interfaces between the control system 106 and the touch sensor system 103, one or more interfaces between the control system 106 and the memory system 108, one or more interfaces between the control system 106 and the display system 110, one or more interfaces between the control system 106 and the optical sensor system 112, one or more interfaces between the control system 106 and the force sensor system 114, one or more interfaces between the control system 106 and the gesture sensor system 116 and/or one or more interfaces between the control system 106 and one or more external device interfaces (e.g., ports or applications processors).

The interface system 104 may be configured to provide communication (which may include wired or wireless communication, electrical communication, radio communication, etc.) between components of the apparatus 101. In some such examples, the interface system 104 may be configured to provide communication between the control system 106 and the fingerprint sensor system 102. According to some such examples, the interface system 104 may couple at least a portion of the control system 106 to the fingerprint sensor system 102 and the interface system 104 may couple at least a portion of the control system 106 to the touch sensor system 103, e.g., via electrically conducting material (e.g., via conductive metal wires or traces. According to some examples, the interface system 104 may be configured to provide communication between the apparatus 101 and other devices and/or human beings. In some such examples, the interface system 104 may include one or more user interfaces. The interface system 104 may, in some examples, include one or more network interfaces and/or one or more external device interfaces (such as one or more universal serial bus (USB) interfaces or a serial peripheral interface (SPI)).

The control system 106 may include one or more general purpose single- or multi-chip processors, digital signal processors (DSPs), application specific integrated circuits (ASICs), field programmable gate arrays (FPGAs) or other programmable logic devices, discrete gates or transistor logic, discrete hardware components, or combinations thereof. According to some examples, the control system 106 also may include one or more memory devices, such as one or more random access memory (RAM) devices, read-only memory (ROM) devices, etc. In this example, the control system 106 is configured for communication with, and for controlling, the display system 110. In implementations wherein the apparatus 101 includes a fingerprint sensor system 102, the control system 106 is configured for communication with, and for controlling, the fingerprint sensor system 102. In implementations wherein the apparatus 101 includes a touch sensor system 103, the control system 106 is configured for communication with, and for controlling, the touch sensor system 103. In implementations wherein the apparatus 101 includes a memory system 108 that is separate from the control system 106, the control system 106 also may be configured for communication with the memory system 108. In implementations wherein the apparatus 101 includes an optical sensor system 112, the control system 106 is configured for communication with, and for controlling, the optical sensor system 112. In implementations wherein the apparatus 101 includes a force sensor system 114, the control system 106 is configured for communication with, and for controlling, the force sensor system 114. According to some examples, the control system 106 may include one or more dedicated components that are configured for controlling the fingerprint sensor system 102, the touch sensor system 103, the memory system 108, the display system 110, the optical sensor system 112 and/or the force sensor system 114.

Some examples of the apparatus 101 may include dedicated components that are configured for controlling at least a portion of the fingerprint sensor system 102 (and/or for processing fingerprint image data received from the fingerprint sensor system 102). Although the control system 106 and the fingerprint sensor system 102 are shown as separate components in FIG. 1, in some implementations at least a portion of the control system 106 and at least a portion of the fingerprint sensor system 102 may be co-located. For example, in some implementations one or more components of the fingerprint sensor system 102 may reside on an integrated circuit or “chip” of the control system 106. According to some implementations, functionality of the control system 106 may be partitioned between one or more controllers or processors, such as between a dedicated sensor controller and an applications processor (also referred to herein as a “host” processor) of an apparatus, such as a host processor of a mobile device. In some such implementations, at least a portion of the host processor may be configured for fingerprint image data processing, determination of whether currently-acquired fingerprint image data matches previously-obtained fingerprint image data (such as fingerprint image data obtained during an enrollment process), etc.

In some examples, the memory system 108 may include one or more memory devices, such as one or more RAM devices, ROM devices, etc. In some implementations, the memory system 108 may include one or more computer-readable media, storage media and/or storage media. Computer-readable media include both computer storage media and communication media including any medium that may be enabled to transfer a computer program from one place to another. Storage media may be any available media that may be accessed by a computer. In some examples, the memory system 108 may include one or more non-transitory media. By way of example, and not limitation, non-transitory media may include RAM, ROM, electrically erasable programmable read-only memory (EEPROM), compact disc ROM (CD-ROM) or other optical disk storage, magnetic disk storage or other magnetic storage devices, or any other medium that may be used to store desired program code in the form of instructions or data structures and that may be accessed by a computer.

In some examples, the apparatus 101 includes a display system 110, which may include one or more displays. In some examples, the display system 110 may be, or may include, a light-emitting diode (LED) display, such as an organic light-emitting diode (OLED) display. In some such examples, the display system 110 may include layers, which may be referred to collectively as a “display stack.”

In some implementations, the apparatus 101 may include an optical sensor system 112. The optical sensor system 112 may include one or more arrays of optical sensor pixels. The one or more arrays of optical sensor pixels may include one or more arrays of active pixel sensors, which may include complementary metal oxide semiconductor (CMOS) sensors, charge coupled device (CCD) image sensors, charge injection device (CID) sensors, or any other sensors capable of detecting changes in light. The optical sensor system 112 may be configured to capture an image using one or more optical sensors (e.g., camera).

In some implementations, the apparatus 101 may include a force sensor system 114. The force sensor system 114 may include one or more force sensors. In some cases, the one or more force sensors may be a plurality of force sensors positioned at different locations of the apparatus 101 under a display of the display system 110. The force sensors may be piezo-resistive sensors, capacitive sensors, thin film sensors (e.g., polymer-based thin film sensors), or other types of suitable force sensors. If the force sensor is a piezo-resistive sensor, the piezo-resistive sensor may include silicon, metal, polysilicon, and/or glass. In some implementations, the one or more force sensors may be mechanically coupled with the fingerprint sensor system 102. In some implementations, the one or more force sensors may be separate from the fingerprint sensor system 102. The one or more force sensors of the force sensor system 114 may be coupled to a portion of the control system 106.

In some implementations, the apparatus 101 may include a gesture sensor system 116. The gesture sensor system 116 may be, or may include, an ultrasonic gesture sensor system, an optical gesture sensor system or any other suitable type of gesture sensor system.

The apparatus 101 may be used in a variety of different contexts, some examples of which are disclosed herein. For example, in some implementations a mobile device may include at least a portion of the apparatus 101. In some implementations, a wearable device may include at least a portion of the apparatus 101. The wearable device may, for example, be a bracelet, an armband, a wristband, a ring, a headband or a patch. In some implementations, the control system 106 may reside in more than one device. For example, a portion of the control system 106 may reside in a wearable device and another portion of the control system 106 may reside in another device, such as a mobile device (e.g., a smartphone). The interface system 104 also may, in some such examples, reside in more than one device.

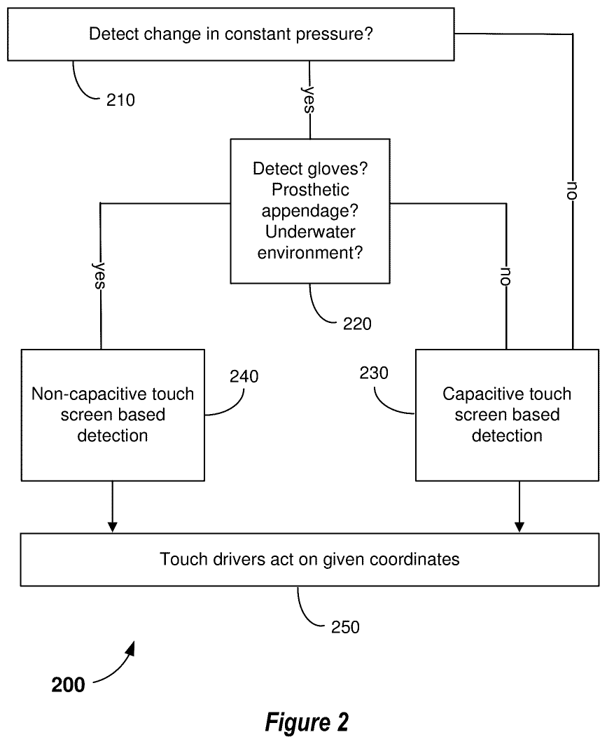

FIG. 2 shows a flow diagram that provides examples of operations for detecting a user context for operating in a non-capacitive touch mode according to some disclosed implementations. In some examples, a process 200 may be performed, at least in part, by the control system 106 of FIG. 1 that is described herein. As with other processes disclosed herein, the operations outlined in FIG. 2 may include different, more, or fewer blocks than indicated. Moreover, the blocks of the process 200 disclosed herein are not necessarily performed in the order indicated. In some implementations, one or more blocks may be performed concurrently.

At block 210 of the process 200, a control system of an apparatus may detect a change in constant pressure. The apparatus may be, or may include, a touch screen device such as a smartphone. The apparatus may be equipped with one or more pressure sensors and/or one or more force sensors. The pressure and/or force sensors may detect a change in pressure exerted on the apparatus. Detection of a change in pressure may be accomplished using only one force sensor or only one pressure sensor, since the pressure and/or force sensors need not estimate position for touch sensing at this stage. As soon as the pressure or force applied on the apparatus exceeds a threshold amount, the control system may initiate a determination whether to enter a non-capacitive touch mode or not. The change in pressure may be induced by a finger tap on the screen, by a water droplet, by an object pressed against the screen, or by any other external or environmental force. The change in pressure may be indicative of a user context that would render touch sensing using a capacitive touch sensor system inoperable.

In some implementations, the control system may be configured to detect a change in an environmental condition such as humidity, temperature, ambient light, etc. Detecting such a change in the environmental condition may be made in the alternative or in addition to detecting a change in constant pressure. For instance, the control system may detect a change in humidity that may be indicative of the apparatus being in wet conditions (e.g., submerged in water). The control system may detect a change in temperature that may be indicative of the apparatus being in cold weather, where the user may be more likely to wear gloves in cold weather. The control system may detect a change in ambient light that may be indicative of an object being in proximity to the apparatus or the apparatus being underwater.

With a detected change in pressure or other specified environmental condition at block 210, the process 200 may proceed to block 220. Without a detected change in pressure or other specified environmental condition, the process 200 may proceed to block 230. At block 230, the apparatus remains in a capacitive touch mode for touch sensing.

At block 220 of the process 200, the control system of the apparatus may identify a source of the change in pressure or environmental condition. Identification of the source of the change may occur by identifying an object in proximity to the display of the apparatus. Identification of the object may be triggered by the change in pressure or specified environmental condition at block 210. In some implementations, identification of the object may proceed by scanning one or more regions of the display using a fingerprint sensor system or optical sensor system. The fingerprint sensor system or the optical sensor system may be configured to scan localized or partial regions of the display to obtain data (e.g., image data) regarding the object in proximity to the display. The data may be used to classify the type of object in proximity to the display of the apparatus. For example, the fingerprint sensor system may be an ultrasonic fingerprint sensor system configured to generate ultrasonic waves. Reflections of the ultrasonic waves may provide unique signal characteristics that can be used to identify the type of object. Different materials may reflect back different acoustic properties, as different materials behave differently in terms of how acoustic waves are reflected back. The acoustic properties may be analyzed to identify the object in proximity to the display of the apparatus. This can be done by analyzing the acoustic waves that reflected back with different frequencies. Using the acoustic properties, the control system may identify the type of object that is in proximity to the display, such as whether the object is solid or liquid, or the type of material that the object is made of. Accordingly, the control system may detect whether the apparatus is underwater, whether the user is wearing gloves, and whether the user is utilizing a prosthetic or robotic hand.

In some implementations, the change in pressure or specified environmental condition detected at block 210 may alternatively trigger presentation of a pop-up, window, or other interface by which the user can select the user context that corresponds to a non-capacitive touch mode or directly select the non-capacitive touch mode. For instance, the user may determine that the apparatus is underwater, that the user is wearing gloves, that the user is utilizing a prosthetic hand, that the user is using a robotic hand, or that the user context otherwise renders capacitive touch sensing inoperable. As such, detected change in pressure or specified environmental condition may trigger an opportunity for the user to initiate having the apparatus enter a non-capacitive touch mode at block 240 or remain in a capacitive touch mode at block 230.

After determining that the apparatus is compatible with touch sensing using a capacitive touch sensor system at block 210 or block 220, the control system may enable touch sensing using the capacitive touch mode at block 230. In the capacitive touch mode, capacitive touch sensors may receive user input that provides a touch location corresponding to an x,y coordinate of a touch sensor coordinate system. Using the coordinates, touch drivers of the control system act on the given coordinates at block 250. However, if the apparatus is determined to be incompatible with touch sensing using a capacitive touch sensor system at block 210 and block 220, the control system may enable touch sensing using the non-capacitive touch mode at block 240. In the non-capacitive touch mode, a fingerprint sensor system, an optical sensor system, a force sensor system, or other sensor system may be employed to receive user input to provide a touch location. In some examples, the touch location may correspond to an active tile in an array of tiles in a designated portion of a graphical user interface. Using the active tile, touch drivers coupled to the control system act on the active tile at block 250.

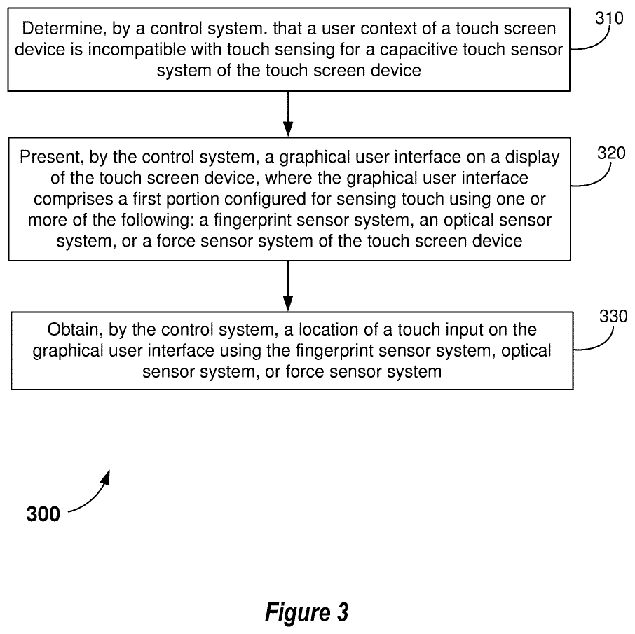

FIG. 3 shows a flow diagram that provides examples of operations for operating in a non-capacitive touch mode according to some disclosed implementations. In some examples, a process 300 may be performed, at least in part, by the control system 106 of FIG. 1 that is described herein. As with other processes disclosed herein, the operations outlined in FIG. 3 may include different, more, or fewer blocks than indicated. Additionally, the blocks of the process 300 disclosed herein are not necessarily performed in the order indicated. In some implementations, one or more blocks may be performed concurrently.

At block 310 of the process 300, a user context of a touch screen device is determined, by a control system, to be incompatible with touch sensing of a touch sensor system. In some implementations, the touch sensor system is a capacitive touch sensor system. Depending on the user context that the touch screen device is operating in, the touch sensor system may be rendered inoperable or substantially inoperable.

As used herein, “user context” generally describes the environment in which the user is located, the current activity of the user, and/or the circumstances in which the user is operating in. The terms “context,” “user context,” and “user environment” are used in this disclosure and are used interchangeably. To list some non-limiting examples, user context may refer to the physical environment in which the user is located, the physical activity of the user, the attire of the user, the transportation mode of the user, and/or the physiological condition of the user.

In some implementations, determination can be made by a user-initiated action. The control system may receive a user input indicating that the user context is incompatible with touch sensing of the touch sensor system, or at least that indicating that the user would like to enter a “special” or “non-capacitive” touch mode.

In some implementations, determination can be made in an automated manner by the control system. The control system may determine a change in an environmental condition and initiate a scan using a fingerprint sensor system or optical sensor system to obtain image data regarding an object in proximity to the touch screen device, where the image data can be used to identify the type of object in proximity to the touch screen device. A pressure sensor or force sensor may detect a change in pressure when a force applied to the touch screen device exceeds a threshold amount. Or, another environmental sensor such as a temperature sensor, humidity sensor, optical sensor, etc. may detect a change in a specified environmental condition. The change in pressure or specified environmental condition may be indicative of a change in user context. This can trigger the control system of the touch screen device to identify the source of the change in pressure or specified environmental condition. In some instances, identification of the source may occur by performing a scan (e.g., low-resolution scan) of certain activated regions of the fingerprint sensor system or optical sensor system to obtain image data regarding an object in proximity to the touch screen device. The image data can be processed to determine if the type of object in proximity to the touch screen device renders the touch sensor system inoperable or substantially inoperable. Examples of user contexts that would render the touch sensor system inoperable or substantially inoperable include but are not limited to: (i) the touch screen device covered or submerged in water, (ii) the user wearing gloves, and (iii) the user utilizing a prosthetic or robotic hand. As such, the image data can be processed to determine if the phase of the object is solid or liquid, if a material of the object is electrically insulating, if the object is water, etc.

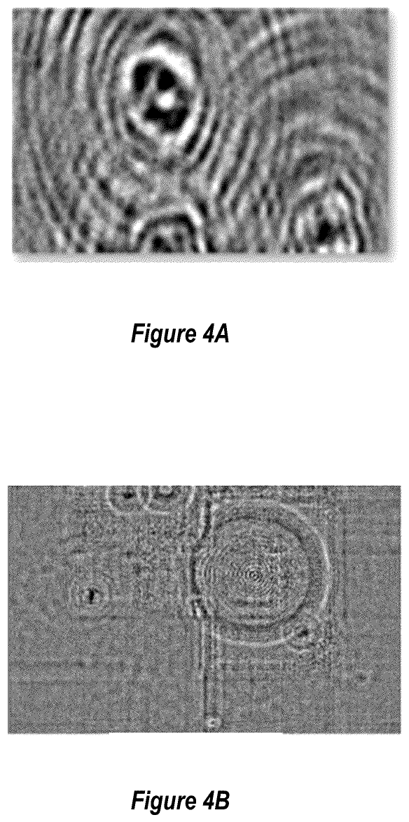

By way of illustration, ultrasonic images may be captured using an ultrasonic fingerprint sensor system. Properties of the ultrasonic images may be analyzed to ascertain information regarding the user context, including information regarding a material of an object in proximity to the touch screen device, a relative size and shape of the object, and a relative proximity of the object. FIG. 4A shows an example ultrasonic image of a touch screen device submerged in water according to some implementations. Having the touch screen device covered or submerged in water would substantially interfere with operation of touch sensing in a capacitive touch sensor system. FIG. 4B shows an example ultrasonic image with water droplets on a surface of a touch screen device according to some implementations. Having the touch screen device covered with only a few droplets of water would not substantially interfere with operation of touch sensing in a capacitive touch sensor system. As shown in the ultrasonic images in FIGS. 4A and 4B, the touch screen device can differentiate between contexts, such as differentiating between having a few droplets of water on a device and having the device submerged in water, that would render touch sensing in a capacitive touch sensor system inoperable or substantially inoperable.

Returning to FIG. 3, at block 320 of the process 300, a graphical user interface (GUI) is presented, by the control system, on a display of the touch screen device. The graphical user interface comprises a first portion configured for sensing touch using one or more of the following: a fingerprint sensor system, an optical sensor system, or a force sensor system of the touch screen device. The first portion may occupy certain regions of a display area of the touch screen device, or the first portion may occupy an entirety or substantial entirety of the display area of the touch screen device. The first portion may be a designated portion of the graphical user interface that is enabled for touch recognition without the assistance of the capacitive touch sensor system.

In some implementations, the graphical user interface includes the first portion and a second portion, where the second portion may be a viewable region for displaying an image or video. The graphical user interface may be divided between a non-touch-sensitive region (the second portion) and a touch-sensitive region (the first portion). In some implementations, the first portion may occupy half, more than half, less than half, or some other fraction of the display area while the second portion may occupy a remainder of the display area.

In some implementations, the first portion occupies a region of the display area that corresponds to an active region of the fingerprint sensor system. Thus, the fingerprint sensor system may be coextensive with the first portion. The active region of the fingerprint sensor system may be an area which an array of fingerprint sensor pixels resides. By way of an example, 4 mm×9 mm or 8 mm×8 mm fingerprint sensors may represent the active region of the fingerprint sensor system in some touch screen devices, which may represent a small fraction of the display area. Touch sensing using the fingerprint sensor system may be limited to a small area of the display area. However, as the active region of the fingerprint sensor system increases, the touch-sensitive region in the non-capacitive touch mode increases.

Depending on the application, the graphical user interface of the application can be repurposed or reformatted in its presentation to accommodate touch-sensitive controls within the active region of the fingerprint sensor system. In some cases, the graphical user interface can present the application and its controls in a window or frame that is coextensive with the active region of the fingerprint sensor system. In some other cases, the graphical user interface can present only the touch-sensitive controls of the application in a window or frame that is coextensive with the active region of the fingerprint sensor system.

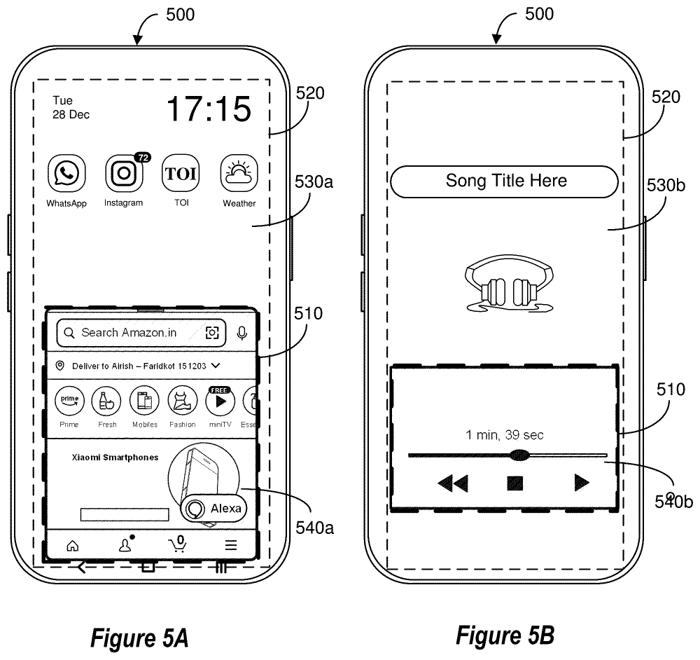

FIG. 5A shows an example of an apparatus with a graphical user interface in a configuration that limits an application to a designated portion of the graphical user interface according to some implementations. FIG. 5B shows an example of an apparatus with a graphical user interface in a configuration that limits only touch-sensitive controls of a music player application to a designated portion of the graphical user interface according to some implementations. As with other disclosed implementations, the scale, numbers, arrangements, and types of elements shown in FIGS. 5A and 5B are merely presented for illustrative purposes. Other implementations of the apparatus 500 may have different numbers, arrangements, and/or types of elements. The apparatus 500 includes a fingerprint sensor system 510 and a display system 520. In some implementations, the fingerprint sensor system 510 includes an ultrasonic fingerprint sensor system. In other implementations, the fingerprint sensor system 510 includes an optical fingerprint sensor system, a photoacoustic fingerprint sensor system, etc. The apparatus 500 may further include a touch sensor system and a control system. The touch sensor system may include a capacitive touch sensor system that is coextensive with the display system 520. In FIGS. 5A and 5B, the fingerprint sensor system 510 has an active area shown in dashed lines outlined by a dashed rectangle. The active area of the fingerprint sensor system 510 resides below the display system 520. The active area of the fingerprint sensor system has an array of fingerprint sensor pixels.

In FIG. 5A, a graphical user interface 530a presented on the display system 520 includes a designated portion 540a. The designated portion 540a is coextensive with the active area of the fingerprint sensor system 510. The designated portion 540a occupies most of the lower half of the graphical user interface 530a. An application and its interface controls are limited to the designated portion 540a, where the designated portion 540a is configured for sensing touch using the fingerprint sensor system 510. In other words, the user is able to interact via touch with the application and its touch-sensitive controls in the designated portion 540a of the graphical user interface 530a. As shown in FIG. 5A, the application is an internet browser. A remaining portion of the graphical user interface 530a shows a home screen with various application icons in the background. The designated portion 540b is coextensive with the active area of the fingerprint sensor system 510, which is smaller than the designated portion 540a of FIG. 5A. The designated portion 540b occupies a fraction of the lower half of the graphical user interface 530b. Touch-sensitive controls of a music player application are limited to the designated portion 540b, where the designated portion 540b is configured for sensing touch using the fingerprint sensor system 510. Put another way, the user is able to interact with the music player via touch with the touch-sensitive controls in the designated portion 540b of the graphical user interface 530b. A remaining portion of the graphical user interface 530b shows an image associated with the music player application. By way of an example, user interface buttons can be displayed in the designated portion 540b while information regarding album art, artist, title, and lyrics can be displayed in the remaining portion of the graphical user interface 530b. Similarly, with a camera application, user interface buttons such as an image capture button can be displayed in the designated portion 540b while view finder information or image can be displayed in the remaining portion of the graphical user interface 530b.

Returning to FIG. 3 of the process 300, after determining that the user context is incompatible with touch sensing using the touch sensor system, touch sensing using the touch sensor system is disabled and touch sensing using the fingerprint sensor system, optical sensor system, and/or force sensor system is enabled in the designated portion of the graphical user interface. Operating the touch screen device without the assistance of the touch sensor system for touch sensing may be referred to as touch sensing in a “special” touch mode or “non-capacitive” touch mode. Alternatively, this may also be referred to as a touch sensing in an “underwater” touch mode, “gloves” touch mode, or “prosthetic” touch mode.

Regardless of whether the designated portion occupies an entirety or only a fraction of the graphical user interface, it is possible that touch sensing using the fingerprint sensor system, the optical sensor system, and/or the force sensor system may not be as accurate as touch sensing using a capacitive touch sensor system. For example, touch resolution for pinpointing touch location using a fingerprint sensor system may be less accurate than touch resolution for pinpointing touch location using a capacitive touch sensor system. In some implementations, the graphical user interface may present larger user interface controls such as larger user interface buttons and icons when operating in the non-capacitive touch mode. This provides improved usability and user satisfaction for registering user inputs with low touch resolution. In addition or in the alternative, the graphical user interface may present a grid or array of M×N tiles for receiving a user input when operating in the non-capacitive touch mode. Each of the tiles may define a sufficiently large space for receiving a touch input when operating with low touch resolution. This also provides improved usability and user satisfaction for registering user inputs with low touch resolution.

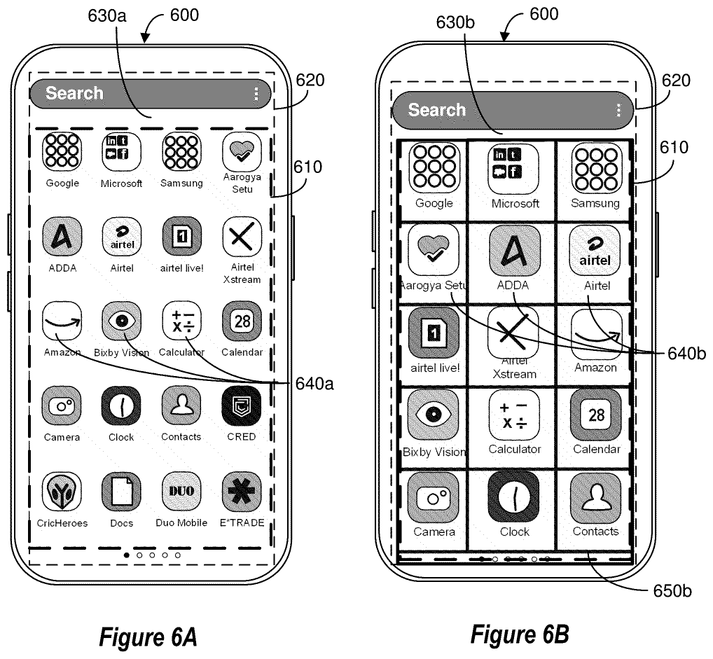

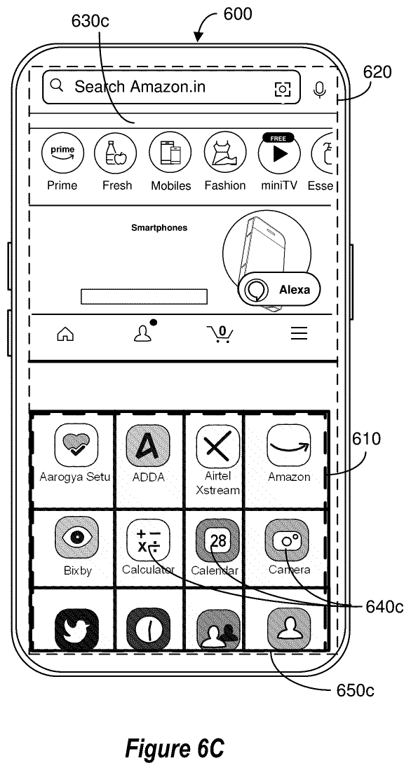

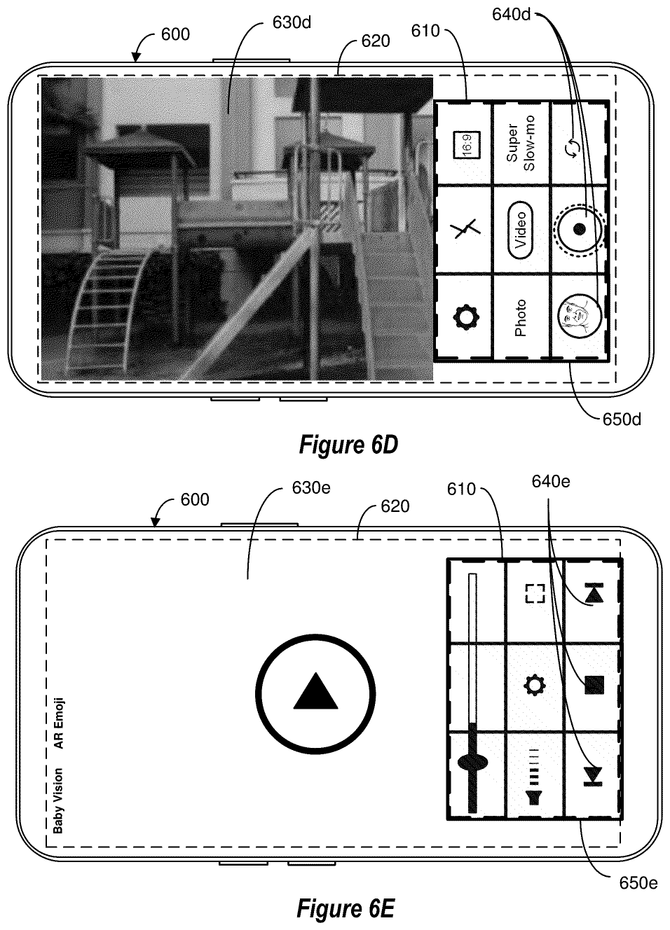

FIG. 6A shows an example of an apparatus with a graphical user interface in a configuration that enables touch sensing in a capacitive touch sensing mode. FIG. 6B shows an example of an apparatus with a GUI in a configuration that enables touch sensing in a non-capacitive touch sensing mode according to some implementations. FIG. 6C shows an example of an apparatus with a GUI in a configuration that enables touch sensing in a non-capacitive touch sensing mode for an application according to some implementations. FIG. 6D shows an example of an apparatus with a GUI in a configuration that enables touch sensing in a non-capacitive touch sensing mode for a camera application according to some implementations. FIG. 6E shows an example of an apparatus with a GUI in a configuration that enables touch sensing in a non-capacitive touch sensing mode for a music player application according to some implementations. As with other disclosed implementations, the scale, numbers, arrangements, and types of elements shown in FIGS. 6A-6E are merely presented for illustrative purposes. Other implementations of the apparatus 600 may have different numbers, arrangements, and/or types of elements. The apparatus 600 includes a fingerprint sensor system 610 and a display system 620. In some implementations, the fingerprint sensor system 610 includes an ultrasonic fingerprint sensor system. In other implementations, the fingerprint sensor system 610 includes an optical fingerprint sensor system, a photoacoustic fingerprint sensor system, etc. The apparatus 600 may further include a touch sensor system and a control system. The touch sensor system may include a capacitive touch sensor system that is coextensive with the display system 620. In FIGS. 6A-6E, the fingerprint sensor system 610 has an active area shown in dashed lines outlined by a grid. The active area of the fingerprint sensor system 610 resides below the display system 620. The active area of the fingerprint sensor system has an array of fingerprint sensor pixels. The active area of the fingerprint sensor system may be larger or smaller than indicated in FIGS. 6A-6E, or may be the same size but in different locations.

Referring to FIG. 6A, a graphical user interface 630a presented on the display system 620 includes a plurality of user interface controls 640a in a “capacitive” touch mode or “normal” touch mode. In the capacitive touch mode or normal mode, the user may interact with the graphical user interface 630a via touch inputs using a touch sensor system such as a capacitive touch sensor system. The plurality of user interface controls 640a may be arranged as icons on the graphical user interface 630a. The icons are neither enlarged nor arranged within a grid or array of tiles.

In contrast, graphical user interfaces 630b, 630c, 630d, 630e presented on the display system 620 of FIGS. 6B-6E include a plurality of user interface controls 640b, 640c, 640d, 640e in a “non-capacitive” touch mode or “special” touch mode. In the non-capacitive touch mode or special mode, the user may interact with the graphical user interfaces 630b, 630c, 630d, 630e via touch inputs using the fingerprint sensor system 610 such as an ultrasonic fingerprint sensor system. However, it will be understood that in the non-capacitive touch mode or special mode, the user may interact with graphical user interfaces via touch inputs using an optical sensor system, force sensor system, or other alternative sensor system. The plurality of user interface controls 640b, 640c, 640d, 640e may be arranged as icons, virtual buttons, sliders, or other controls on the graphical user interface 630b, 630c, 630d, 630e.

The plurality of user interface controls 640b, 640c, 640d, 640e may be arranged within a grid or an array of tiles 650b, 650c, 650d, 650e, respectively. The array of tiles 650b, 650c, 650d, 650e may occupy an area that is coextensive with the active area of the fingerprint sensor system 610. As discussed below, when touch or force is applied on the display system 620, fingerprint sensor pixels corresponding to one or more tiles 650b may be scanned to identify a user's finger and determine touch location. In these instances the graphical user interface 630b is divided into the array of tiles 650b first and then a scan is performed to determine touch location. Or, when touch or force is applied on the display system 620, fingerprint sensor pixels are scanned or at least partially scanned to identify a user's finger, which is then correlated to a particular tile in the array of tiles 650b to determine touch location. In such instances the scan is performed first and then the graphical user interface 630 is divided into the array of tiles 650b to determine touch location.

As illustrated in FIG. 6B, the plurality of user interface controls 640b are icons are enlarged icons on a home page of the graphical user interface 630b. Compared to the plurality of user interface controls 640a in FIG. 6A, the plurality of user interface controls 640b in FIG. 6B are larger and arranged in an array of tiles 650b. As illustrated in FIG. 6C, the plurality of user interface controls 640c occupy a lower half of the graphical user interface 630c. The lower half has a region designated for sensing touch and an upper half has a region designated for displaying an image, video, or other information. The user interface controls 640c may be icons in the lower half arranged in the array of tiles 650d. As illustrated in FIG. 6D, the plurality of user interface controls 640d are virtual buttons of a camera application located on a right side of the graphical user interface 630d. A remainder of the graphical user interface 630d displays the view finder or image of the camera application. The plurality of user interface controls 640d may be virtual buttons arranged in the array of tiles 650d. As illustrated in FIG. 6E, the plurality of user interface controls 640e are virtual buttons and a slider of a music player application located on a right side of the graphical user interface 630e. A remainder of the graphical user interface 630e displays information of the music player application. The plurality of user interface controls 640e may be virtual buttons and a slider arranged in the array of tiles 650e.

Returning to FIG. 3, at block 330 of the process 300, a location of a touch input on the graphical user interface is obtained by the control system using the fingerprint sensor system, optical sensor system, or force sensor system. As discussed above, at least the first portion of the graphical user interface is configured for sensing touch using the fingerprint sensor system, optical sensor system, or force sensor system. One or more pressure or force sensors may detect a touch or force applied on the display of the touch screen device to determine that a touch input is received on the graphical user interface. The one or more pressure or force sensors may be associated with the fingerprint sensor system, force sensor system, or other sensor system. Upon detection of the touch input, the control system can obtain the location of the touch input using one of several approaches.

In some implementations, the location of the touch input can be obtained using the fingerprint sensor system. The fingerprint sensor system may perform a scan of one or more regions of the first portion to identify an object (e.g., user's finger). The scanned object can be correlated with a coordinate in the first portion or with an active tile in an array of tiles, thereby obtaining the location of the touch input.

The fingerprint sensor system may be an ultrasonic fingerprint sensor system. The ultrasonic fingerprint sensor system may include an ultrasonic transmitter or transceiver configured to generate ultrasonic waves. The ultrasonic fingerprint sensor system may include an ultrasonic receiver or transceiver configured to receive reflections of the ultrasonic waves, where the ultrasonic receiver may include a piezoelectric receiver array. In some cases, the piezoelectric receiver array may be divided into segments so that some or all segments are scanned for ultrasonic imaging. In some implementations, the control system may scan all areas of the piezoelectric receiver array. In some implementations, the control system may select a scanning area of the piezoelectric receiver array. For instance, different areas may be scanned until a user's finger is identified in one of the scanned areas.

In one example, one or more fingerprint sensor pixels are scanned until a user's finger is identified. The scan may be a full scan or a partial scan of the active region of the fingerprint sensor system. The first portion of the graphical user interface may be divided into an M×N array of tiles. The fingerprint sensor pixel that scanned the user's finger may be correlated to an active tile in the M×N array of tiles. The location of the active tile provides the location of the touch input.

In another example, the first portion of the graphical user interface may be divided into an M×N array of tiles. The fingerprint sensor system performs a scan of one or more tiles until a user's finger is identified. The user's finger is correlated to an active tile in the M×N array of tiles, and the location of the active tile provides the location of the touch input.

In some implementations, the control system scans one or more areas of the fingerprint sensor system to acquire image data. The scan may be initiated by a stylus, pen, or other object in contact with the display of the touch screen device. The acquired image data may correspond to signals produced by a piezoelectric receiver array in response to an ultrasonic signal and/or a mechanical deformation caused by the object in contact with a surface such as a cover glass of the touch screen device. In some instances, the object is a stylus. The control system may be configured to detect a doublet pattern or ring pattern in the acquired image data. Using the acquired image data, the control system may be configured to detect a position of the object on the surface of the touch screen device to provide a location of the touch input.

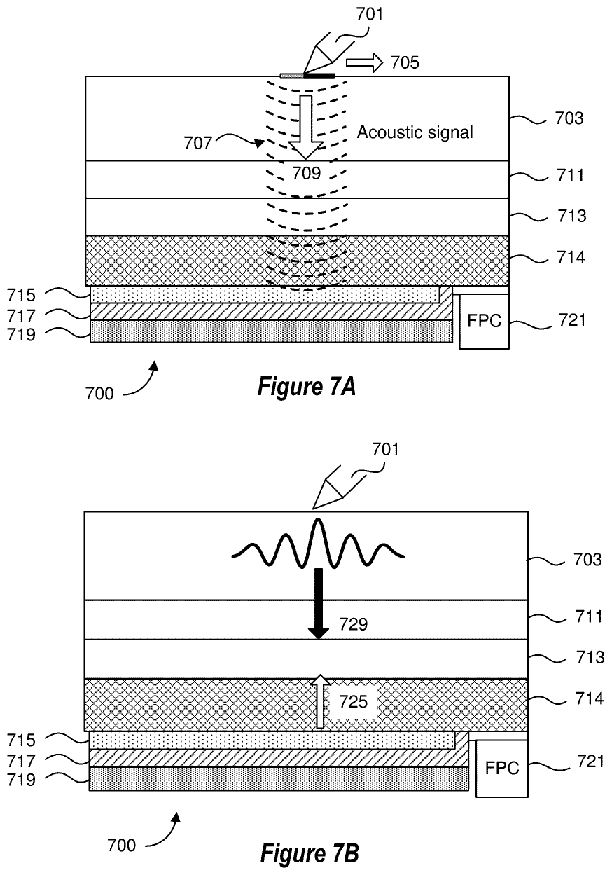

FIG. 7A shows a cross-sectional schematic view of an example fingerprint sensor system configured for touch detection using mechanical deformation according to some implementations. FIG. 7B shows a cross-sectional schematic view of an example fingerprint sensor system configured for touch detection using ultrasonic reflection according to some implementations. In FIGS. 7A and 7B, a stylus 701 is in contact with a cover glass 703 of an apparatus 700. A display 711 underlies the cover glass 703. The display 711 may include an LED display, an OLED display, or other suitable display. The apparatus 700 includes a thin-film transistor (TFT) substrate 714 that includes a piezoelectric receiver array, which can be an ultrasonic sensor array in this instance. In some implementations, an adhesive 713 couples the TFT substrate 714 to the display 711. A piezoelectric layer 715 is coupled to the TFT substrate 714. The piezoelectric layer 715 may include one or more ferroelectric polymers such as polyvinylidene fluoride (PVDF) or polyvinylidene fluoride-trifluoroethylene (PVDF-TrFE) copolymers. Examples of PVDF copolymers include 60:40 (molar percent) PVDF-TrFE, 70:30 PVDF-TrFE, 80:20 PVDF-TrFE, and 90:10 PVDR-TrFE. Alternatively, or additionally, the piezoelectric layer 715 may include one or more other piezoelectric materials such as polyvinylidene chloride (PVDC) homopolymers or copolymers, polytetrafluoroethylene (PTFE) homopolymers or copolymers, diisopropylammonium bromide (DIPAB), aluminum nitride (AlN) and/or lead zirconate titanate (PZT). The apparatus 700 includes an electrode layer 717 adjacent to the piezoelectric layer 715 and a passivation layer 719 adjacent to the electrode layer 717. In this instance, at least a portion of the control system 706 is configured for electrical communication with the electrode layer 717, the piezoelectric layer 715, and the TFT substrate 714 via a flexible printed circuit 721.

In FIG. 7A, the stylus 701 is moving in a direction indicated by an arrow 705. Acoustic waves 707 generated by interaction of the stylus 701 with the cover glass 703 propagate in a direction of an arrow 709 (as well as in other directions). The apparatus 700 detects mechanical deformation caused by the stylus 701. Such “passive” implementations can be energy-efficient because it is not necessary to use an active transmitter, such as an ultrasonic transmitter, for tracking the stylus 701. The acoustic waves 707 caused by mechanical deformation provide signals to the TFT substrate 714 to acquire image data that can be analyzed to obtain a location of the stylus 701. In some implementations, the acquired image data may indicate the location of the stylus 701 in a doublet pattern.

In FIG. 7B, the stylus 701 is in contact with the cover glass 703. Ultrasonic waves are generated by the piezoelectric layer 715 in an ultrasonic transmitter. Generated ultrasonic waves are indicated by an arrow 725 pointing upwards. One or more segments of the electrode layer 717 may receive a voltage (e.g., tone burst) to cause the piezoelectric layer 715 to generate ultrasonic waves. Reflections of the ultrasonic waves caused by the stylus 701 are received by the TFT substrate 714. Reflected ultrasonic waves are indicated by an arrow 729 pointing downwards. The reflected ultrasonic waves provide signals to the TFT substrate 714 to acquire image data that can be analyzed to obtain a location of the stylus 701. In some implementations, the acquired image data may indicate the location of the stylus 701 in a ring pattern.

Returning to FIG. 3 of the process 300, the location of the touch input can be obtained using the optical sensor system in some implementations. The optical image system may include an array of optical sensor pixels that scan an image of an object (e.g., user's finger) in contact with a cover glass or display of the touch screen device. The scanned image can be correlated with a location of the touch input in the first portion of the graphical user interface.

In some implementations, the location of the touch input can be obtained using the force sensor system. The force sensor system may include a plurality of force sensors positioned at different locations of the touch screen device. When force is applied at a particular location on the touch screen device, each of the plurality of force sensors may obtain force measurements. The force measurements at each of the different locations of the touch screen device may be used to calculate the location of maximum force. The location of the maximum force corresponds to the location of the object applying the force. The force measurements from the plurality of force sensors are used to triangulate the location of touch. As such, the location of the object applying the force can be estimated based on the plurality of force measurements at different locations.

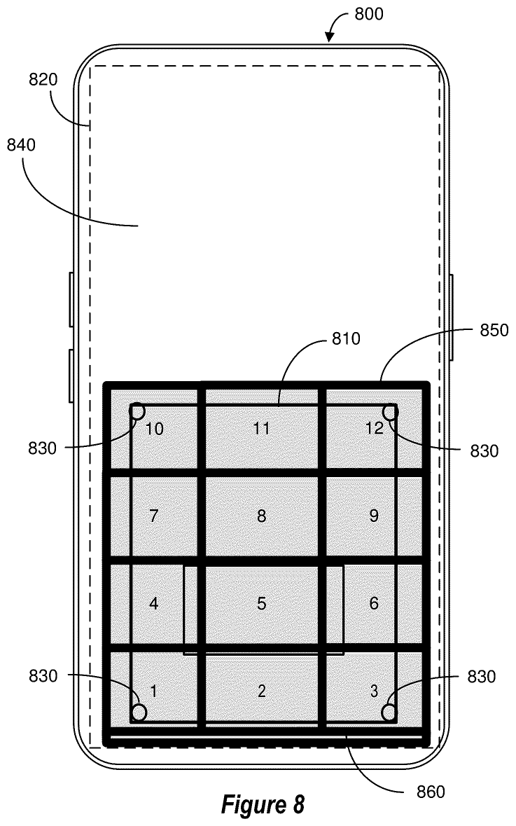

FIG. 8 shows a schematic block diagram of an example force sensor system configured for touch detection using a plurality of force sensors according to some implementations. The apparatus 800 includes a force sensor system 810 and a display system 820. The force sensor system 810 may include a plurality of force sensors 830. The apparatus 800 may further include a touch sensor system and a control system. The touch sensor system may include a capacitive touch sensor system that is coextensive with the display system 620. In FIG. 8, a graphical user interface 840 includes a designated portion 850 that is divided into an array of tiles 860. The tiles 860 are numbered 1-12 in the designated portion 850. The designated portion 850 overlaps the force sensor system 810 and serves as a touch-sensitive region of the graphical user interface 840. Force sensors 830 may be located at each corner of the designated portion 850 under tile numbers 1, 3, 10, and 12. When force is applied by an object on the display system 820, force measurements obtained by the force sensors 830 may be used to calculate a location of the applied force. The location of the applied force may correspond to one of the tiles 860. As shown in FIG. 8, the location of the applied force is tile number 5.

Returning to FIG. 3, one or more touch drivers of the touch screen device may receive the location of the touch input from the control system. The one or more touch drivers perform an operation based on the location of the touch input.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, e.g., a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, i.e., one or more modules of computer program instructions, encoded on a computer storage media for execution by, or to control the operation of, data processing apparatus.

If implemented in software, the functions may be stored on or transmitted over as one or more instructions or code on a computer-readable medium, such as a non-transitory medium. The processes of a method or algorithm disclosed herein may be implemented in a processor-executable software module which may reside on a computer-readable medium. Computer-readable media include both computer storage media and communication media including any medium that may be enabled to transfer a computer program from one place to another. Storage media may be any available media that may be accessed by a computer. By way of example, and not limitation, non-transitory media may include RAM, ROM, EEPROM, CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those having ordinary skill in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein, if at all, to mean “serving as an example, instance, or illustration.” Any implementation described herein as “exemplary” is not necessarily to be construed as preferred or advantageous over other implementations.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, other implementations are within the scope of the following claims. In some cases, the actions recited in the claims may be performed in a different order and still achieve desirable results.

It will be understood that unless features in any of the particular described implementations are expressly identified as incompatible with one another or the surrounding context implies that they are mutually exclusive and not readily combinable in a complementary and/or supportive sense, the totality of this disclosure contemplates and envisions that specific features of those complementary implementations may be selectively combined to provide one or more comprehensive, but slightly different, technical solutions. It will therefore be further appreciated that the above description has been given by way of example only and that modifications in detail may be made within the scope of this disclosure.

1. An apparatus, comprising:
a display;
a capacitive touch sensor system;
one or more of the following: a fingerprint sensor system, an optical sensor system, or a force sensor system; and
a control system configured for communication with the capacitive touch sensor system, the fingerprint sensor system, and the display, wherein the control system is further configured for:
determine that a user context of the apparatus is incompatible with touch sensing for the touch sensor system; and
present a graphical user interface on the display of the apparatus, wherein the graphical user interface comprises a first portion configured for sensing touch using one or more of the following: the fingerprint sensor system, the optical sensor system, or the force sensor system.

2. The apparatus of claim 1, wherein the first portion comprises a region of the display coextensive with an active area of the fingerprint sensor system.

3. The apparatus of claim 1, wherein the graphical user interface further comprises a second portion, wherein the second portion of the graphical user interface is configured to display a video or image.

4. The apparatus of claim 1, wherein the control system configured to determine that the user context is incompatible with touch sensing for the capacitive touch sensor system is configured to determine that the user context comprises one or more of the following: (i) the display of the apparatus is covered or submerged in water, (ii) a user wearing gloves, or (iii) a user utilizing a prosthetic or robotic hand.

5. The apparatus of claim 1, wherein the control system configured to determine that the user context is incompatible with touch sensing for the capacitive touch sensor system is configured to:
identify an object in proximity to the apparatus; and
determine that the object is incompatible with touch sensing for the capacitive touch sensor system.

6. The apparatus of claim 5, wherein the control system configured to identify the object in proximity to the apparatus is configured to:
detect a change in pressure on the apparatus using one or more pressure or force sensors associated with the force sensor system or fingerprint sensor system, wherein the change in pressure is indicative of the object being in proximity to the apparatus;
scan an image of the object in proximity to the apparatus using the optical sensor system or the fingerprint sensor system; and
classify the object based on the image.

7. The apparatus of claim 1, wherein the control system is further configured to:
obtain a location of a touch input on the graphical user interface using the fingerprint sensor system.

8. The apparatus of claim 7, wherein the control system configured to obtain the location of the touch input on the graphical user interface using the fingerprint sensor system is configured to:
divide the first portion of the graphical user interface into an array of tiles corresponding to active areas of the fingerprint sensor system; and
perform a scan of one or more tiles of the array of tiles using the fingerprint sensor system to identify a user's finger; and
correlate the user's finger with one of the tiles in the first portion of the graphical user interface to obtain the location of the touch input.

9. The apparatus of claim 7, wherein the control system configured to obtain the location of the touch input on the graphical user interface using the fingerprint sensor system is configured to:
detect an applied force on the display using one or more pressure or force sensors associated with the force sensor system or fingerprint sensor system;
perform a scan using the fingerprint sensor system to identify a user's finger; and
correlate the user's finger with at least one tile in an array of tiles in the first portion of the graphical user interface to obtain the location of the touch input, wherein the array of tiles divides the first portion into a grid.

10. The apparatus of claim 7, wherein the fingerprint sensor system comprises an ultrasonic fingerprint sensor system.

11. The apparatus of claim 10, wherein the control system configured to obtain the location of the touch input on the graphical user interface using the fingerprint sensor system is configured to:
cause an ultrasonic transmitter or transceiver in the ultrasonic fingerprint sensor system to generate ultrasonic waves;
receive reflections of the ultrasonic waves at a piezoelectric receiver array to acquire image data that identifies a stylus or pen in contact with a surface of the apparatus; and
correlate the stylus or pen to a position in the first portion of the graphical user interface to obtain the location of the touch input using the image data.

12. The apparatus of claim 10, wherein the control system configured to obtain the location of the touch input on the graphical user interface using the fingerprint sensor system is configured to:
receive an indication of mechanical deformation at a piezoelectric receiver array of the ultrasonic fingerprint sensor system to acquire image data that identifies a stylus or pen in contact with a surface of the apparatus; and
correlate the stylus or pen to a position in the first portion of the graphical user interface to obtain the location of the touch input using the image data.

13. The apparatus of claim 1, wherein the control system is further configured to:
obtain a location of a touch input on the graphical user interface using the force sensor system, wherein the control system configured to obtain the location of the touch input using the force sensor system is configured to:
detect an applied force from an object on the display;
obtain a plurality of force measurements from a plurality of force sensors associated with the force sensor system, each of the plurality of force sensors positioned at different locations of the apparatus; and
estimate a position of the object in the first portion of the graphical user interface based on the plurality of force measurements to obtain a location of the touch input.

14. A method, comprising:
determining, using a control system, that a user context of a touch screen device is incompatible with touch sensing for a capacitive touch sensor system of the touch screen device; and
presenting, using the control system, a graphical user interface on a display of the touch screen device, wherein the graphical user interface comprises a first portion configured for sensing touch using one or more of the following: a fingerprint sensor system, an optical sensor system, or a force sensor system of the touch screen device.

15. The method of claim 14, wherein the first portion of the graphical user interface comprises a region of the display coextensive with an active area of the fingerprint sensor system.

16. The method of claim 14, wherein the graphical user interface further comprises a second portion, wherein the second portion of the graphical user interface is configured to display a video or image.

17. The method of claim 14, wherein the user context that is incompatible with touch sensing for the capacitive touch sensor system comprises one or more of the following: (i) the display of the touch screen device is covered or submerged in water, (ii) a user wearing gloves, or (iii) a user utilizing a prosthetic or robotic hand.

18. The method of claim 14, wherein determining that the user context of the touch screen device is incompatible with touch sensing for the capacitive touch sensor system comprises:
identifying an object in proximity to the touch screen device; and
determining that the object is incompatible with touch sensing for the capacitive touch sensor system of the touch screen device.

19. The method of claim 18, wherein identifying the object in proximity to the touch screen device comprises:
detecting a change in pressure on the touch screen device using one or more pressure or force sensors associated with the force sensor system or the fingerprint sensor system, wherein the change in pressure is indicative of the object being in proximity to the touch screen device;
scanning an image of the object in proximity to the touch screen device using the optical sensor system or fingerprint sensor system; and
classifying the object based on the image.

20. The method of claim 14, further comprising:
obtaining, using the control system, a location of a touch input on the graphical user interface using the fingerprint sensor system.

21. The method of claim 20, wherein obtaining the location of the touch input on the graphical user interface using the fingerprint sensor system comprises:
dividing the first portion of the graphical user interface into an array of tiles corresponding to active areas of the fingerprint sensor system;
performing a scan of one or more tiles of the array of tiles using the fingerprint sensor system to identify a user's finger; and
correlating the user's finger with one of the tiles in the first portion of the graphical user interface to obtain the location of the touch input.

22. The method of claim 20, wherein obtaining the location of the touch input on the graphical user interface using the fingerprint sensor system comprises:
detecting an applied force on the display using one or more pressure or force sensors associated with the force sensor system or fingerprint sensor system;
performing a scan using the fingerprint sensor system to identify a user's finger; and
correlating the user's finger with at least one tile in an array of tiles in the first portion of the graphical user interface to obtain the location of the touch input, wherein the array of tiles divides the first portion into a grid.

23. The method of claim 20, wherein the fingerprint sensor system comprises an ultrasonic fingerprint sensor system.

24. The method of claim 23, wherein obtaining the location of the touch input on the graphical user interface using the fingerprint sensor system comprises:
causing an ultrasonic transmitter or transceiver in the ultrasonic fingerprint sensor system to generate ultrasonic waves;
receiving reflections of the ultrasonic waves at a piezoelectric receiver array to acquire image data that identifies a stylus or pen in contact with a surface of the touch screen device; and
correlating the stylus or pen to a position in the first portion of the graphical user interface to obtain the location of the touch input using the image data.

25. The method of claim 23, wherein obtaining the location of the touch input on the graphical user interface using the fingerprint sensor system comprises:
receiving an indication of mechanical deformation at a piezoelectric receiver array of the ultrasonic fingerprint sensor system to acquire image data that identifies a stylus or pen in contact with a surface of the touch screen device; and
correlating the stylus or pen to a position in the first portion of the graphical user interface to obtain the location of the touch input using the image data.

26. The method of claim 14, further comprising:
obtaining a location of a touch input on the graphical user interface using the optical sensor system.

27. The method of claim 14, further comprising:
obtaining a location of a touch input on the graphical user interface using the force sensor system, wherein obtaining the location of the touch input using the force sensor system comprises:
detecting an applied force from an object on the display;
obtaining a plurality of force measurements from a plurality of force sensors associated with the force sensor system, each of the plurality of force sensors positioned at different locations of the touch screen device; and
estimating a position of the object in the first portion of the graphical user interface based on the plurality of force measurements to obtain a location of the touch input.

28. One or more non-transitory media having software recorded thereon, the software including instructions for controlling one or more devices to perform a method, the method comprising:
determining that a user context of a touch screen device is incompatible with touch sensing for a capacitive touch sensor system of the touch screen device; and
presenting a graphical user interface on a display of the touch screen device, wherein the graphical user interface comprises a first portion configured for sensing touch using one or more of the following: a fingerprint sensor system, an optical sensor system, or a force sensor system of the touch screen device.

29. The one or more non-transitory media of claim 28, wherein the user context that is incompatible with touch sensing for the capacitive touch sensor system comprises one or more of the following: (i) the display of the touch screen device is covered or submerged in water, (ii) a user wearing gloves, or (iii) a user utilizing a prosthetic or robotic hand.

30. The one or more non-transitory media of claim 28, the method further comprising:
obtaining a location of a touch input on the graphical user interface using the fingerprint sensor system.
